(19) United States
(12) Patent Application Publication
(10) Pub. No.: US 2022/0194835 A1
(43) Pub. Date: Jun. 23, 2022

(54) METHOD AND SYSTEM FOR REDUCING TOTAL CARBON CONSUMPTION IN THE GENERATION OF LOW CHEMICAL OXYGEN DEMAND TREATED STREAMS

(71) Applicant: SIEMENS ENERGY, INC., Orlando, FL (US)

(72) Inventor: Simon Larson, Wausau, WI (US)

(21) Appl. No.: 17/599,683

(22) PCT Filed: Mar. 26, 2020
(86) PCT No.: PCT/US2020/025006

§ 371 Date: Sep. 29, 2021

Related U.S. Application Data
(60) Provisional application No. 62/829,948, filed on Apr. 5, 2019.

(51) Int. Cl. C02F 9/00

(52) U.S. Cl. CPC C02F 9/00; C02F 1/283

(57) ABSTRACT

The present inventors have developed systems and processes for reducing the overall carbon consumption needed for the generation of low COD treated water. In certain aspects, the systems and processes described herein include an oxidation stage (e.g., one that utilizes ozone, hydrogen peroxide, ultraviolet, or a combination thereof for oxidation) between a first activated carbon stage and a second activated carbon stage to reduce a total carbon consumption within the associated system or process.

### FIELD

This invention relates to treatment processes and systems, and in particular to processes and systems which reduce total activated carbon consumption utilized to produce low chemical oxygen demand (COD) treated streams.

### BACKGROUND

Wastewater streams are commonly treated by a wide variety of processes in order to remove organics, solids, and any other undesirable contaminants therefrom. For example, wastewater streams may be contacted with activated carbon for a time effective to remove an amount of chemical oxygen demand (COD) therefrom. In some instances, activated carbon is further combined with biological material, the latter of which is suitable for the removal of readily biodegradable organics from the wastewater stream. Globally, wastewater streams are requiring lower maximum allowable levels of COD and like contaminants. To arrive at these lower levels (e.g., <50 mg/L COD), in many instances, two activated carbon stages (activated carbon in two or more separate vessels) may be provided in series to achieve the desired lower COD concentration.

Having two activated carbon stages, however, requires a significant overall or total carbon consumption in the associated system and process, which requires significant cost, storage, and transportation of materials. To reduce the total carbon consumption, spent activated carbon from the stages may be regenerated by wet air oxidation (WAO) at an elevated temperature, elevated pressure, and in the presence of an oxygen-containing gas. This recycling of the carbon will lower the amount of fresh carbon needed. However, the total carbon consumption needed in a two stage system to reduce COD levels below their maximum allowable limit for most commercial applications is typically too great for a single WAO unit. Due to the proliferation of large industrial park wastewater complexes or integrated refinery facilities coupled with decreasing effluent limits, the WAO unit has become excessively large or requires two units. The repeated addition of significant fresh activated carbon and/or the addition of a second WAO unit can significantly increase the costs of the associated system or process.

### SUMMARY

The present inventors have developed systems and processes for reducing the overall carbon consumption needed for the generation of low COD treated water. In certain aspects, the systems and processes described herein include an oxidation stage (e.g., one that utilizes ozone, hydrogen peroxide, ultraviolet, or any other suitable oxidant/oxidizing agent or a combination thereof for oxidation) between a first activated carbon stage and a second activated carbon stage to reduce a total carbon consumption within the associated system or process. Without wishing to be bound by theory, it is believed that oxidation between the two activated carbon stages may significantly reduce total activated carbon needed to achieve low COD (<50 mg/L) treated wastewater. In certain embodiments, the presence of the oxidation stage reduces a total carbon consumption by 25% by mass or greater.

In accordance with another aspect, the systems and processes described herein utilize two or more carbon stages, each comprising a combination of activated carbon and biomass to reduce chemical oxygen demand (COD) in a wastewater stream. The presence of an oxidation stage which oxidizes a treated stream from a first carbon stage (optionally comprising biomass) results is an increased fraction of biodegradable COD and/or an overall decrease in COD, relative to the first treated stream. This allows the COD concentration to be more easily reduced in the second carbon stage by biomass therein, thereby reducing the carbon required in the second stage and the total carbon consumption of the system.

In accordance with an aspect of the present invention, there is provided a water treatment system comprising: (i) a first carbon stage comprising a first vessel containing at least a first amount of activated carbon effective to reduce a first amount of chemical oxygen demand (COD) from a wastewater stream and generate a first treated stream having a first reduced amount of COD; (ii) an oxidation unit disposed downstream of the first carbon stage, the oxidation unit configured to oxidize a second amount of COD from the first treated stream and generate a second treated stream having a second reduced amount of COD; and (iii) a second carbon stage downstream of the oxidation unit comprising a second vessel containing at least a second amount of activated carbon effective to reduce a third amount of chemical oxygen demand (COD) from the second treated stream and generate a third treated stream having a third reduced amount of COD at or below a predetermined concentration limit.

In accordance with another aspect, there is provided a water treatment process comprising: (i) generating a first treated stream having a first reduced amount of COD via contacting a wastewater stream with a first amount of activated carbon; (ii) generating a second treated stream having a second reduced amount of COD via subjecting the first treated stream to an oxidation process; and (iii) generating a third treated stream having a third reduced amount of COD at or below a predetermined concentration limit via contacting the second treated stream with at least a second amount of activated carbon; wherein, relative to a process without the oxidation step, the oxidation process reduces a total carbon consumption required to bring the COD to or below the predetermined concentration limit.

In accordance with another aspect, there is provided a water treatment system comprising: (i) a first bioreactor comprising a first amount of activated carbon and a first amount of biomass, the first bioreactor configured to remove a first amount of chemical oxygen demand (COD) from a wastewater stream introduced thereto and to generate a first treated stream comprising a first reduced amount of COD along with a first solids portion comprising the first amount of activated carbon and biomass; (ii) a first separator in fluid communication with the first bioreactor, the first separator configured to separate the first treated stream from the first solids portion; (iii) an oxidation unit in fluid communication with first separator, the oxidation unit configured to oxidize an amount of the COD in the first treated stream and generate a second treated stream comprising a second reduced amount of COD; (iv) a second bioreactor comprising a second amount of activated carbon and a second amount of biomass in fluid communication with the oxidation unit, the second bioreactor configured to remove a third amount of COD from the second treated stream to generate a third treated stream comprising a reduced amount of COD along with a second solids portion comprising the second amount of activated carbon and biomass; and (v) a second separator in fluid communication with the second bioreactor, the second separator configured to separate the third treated stream from the second solids portion.

In accordance with another aspect, there is provided a water treatment process comprising: (i) treating a wastewater stream comprising an amount of chemical oxygen demand (COD) therein in a first bioreactor comprising a first amount of activated carbon and a first amount of biomass therein; (ii) generating a first treated stream comprising a first reduced COD concentration from the first bioreactor; (iii) oxidizing the first treated stream to generate a second treated stream comprising a second reduced COD concentration; (iv) treating the second treated stream in a second bioreactor comprising a second amount of activated carbon and a second amount of biomass therein; and (v) generating a third treated stream comprising a third reduced COD concentration from the second bioreactor.

### BRIEF DESCRIPTION

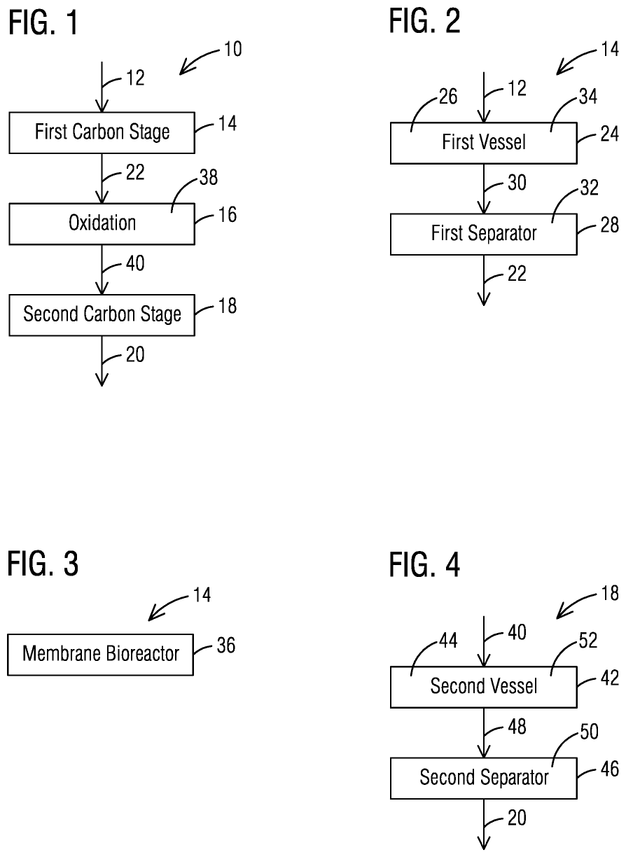

FIG. 1 illustrates a wastewater treatment system for reducing total carbon consumption in the treatment of wastewater to low chemical oxygen demand (COD) concentrations in accordance with an aspect of the present invention.

FIG. 2 illustrates an embodiment of a first carbon stage in a system in accordance with an aspect of the present invention.

FIG. 3 illustrates an embodiment of a membrane bioreactor first carbon stage in the system in accordance with an aspect of the present invention.

FIG. 4 illustrates an embodiment of a system carbon stage in a system in accordance with an aspect of the present invention.

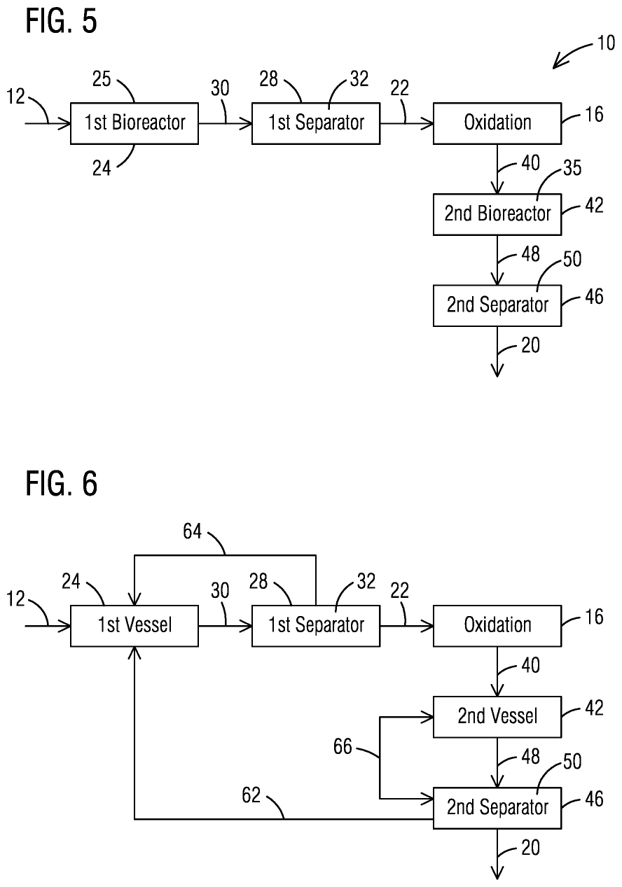

FIG. 5 illustrates a wastewater treatment system for reducing total carbon consumption in the treatment of wastewater to low chemical oxygen demand (COD) concentrations in accordance with another aspect of the present invention.

FIG. 6 illustrates the movement of materials through a wastewater treatment system in accordance with an aspect of the present invention.

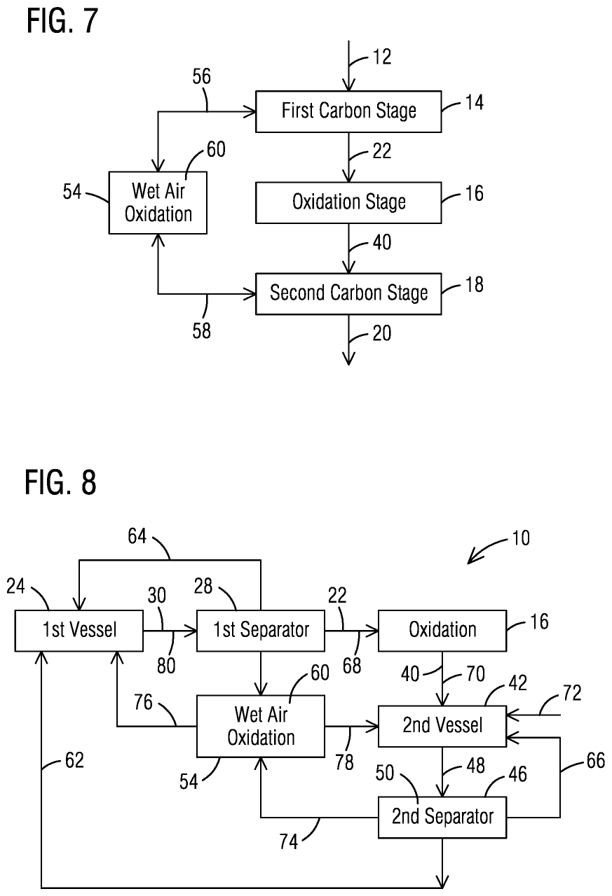

FIG. 7 illustrates a wastewater treatment system further comprising a wet air oxidation unit in accordance with an aspect of the present invention.

FIG. 8 illustrates a wastewater treatment system further comprising a wet air oxidation unit in accordance with another aspect of the present invention.

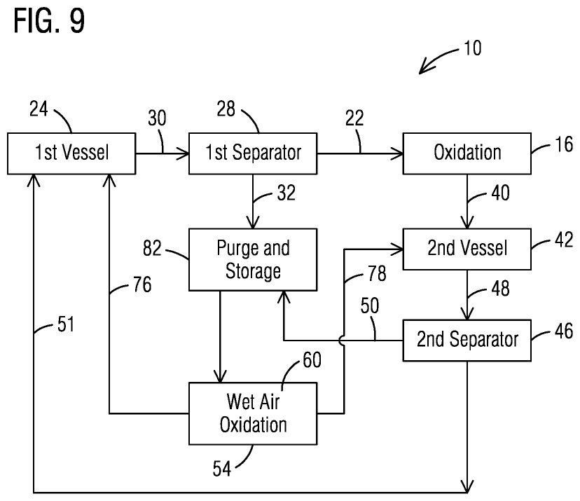

FIG. 9 illustrates a wastewater treatment system further comprising a purge and storage system in accordance with another aspect of the present invention

### DETAILED DESCRIPTION

Now referring to the figures, FIG. 1 illustrates embodiment of a water treatment system 10 in accordance with an aspect of the present invention for treating a wastewater stream 12 comprising an amount of chemical oxygen demand (COD) therein, which also reduces an overall carbon requirement for the system. As shown, the wastewater stream 12 flows through (in flow series) a first carbon stage 14, an oxidation unit 16, and a second carbon stage 18 to provide a treated stream 20 having an amount of COD below a maximum allowable limit (e.g., 50 mg/L, and in certain embodiments 30 mg/L). The wastewater stream 12 may refer to any fluid comprising an amount of chemical oxygen demand (COD) therein. In certain embodiments, the wastewater stream 12 may comprise one from an industrial, agricultural, or municipal source. In certain embodiments, the COD comprises an amount of organic and inorganic contaminants. In addition, in certain embodiments, the wastewater stream 12 is one that includes biodegradable contaminants, e.g., biodegradable organics, as well as recalcitrant organics, which are difficult to biodegrade and best removed from stream 12 by activated carbon and/or assisted by oxidation. In particular embodiments, the wastewater stream 12 may comprise a waste stream from a petrochemical production or a refinery process, such as an oil refinery process.

The first carbon stage 14 may comprise any suitable components in a configuration which at least utilizes an amount of activated carbon effective to reduce a first amount of chemical oxygen demand (COD) from the wastewater stream 12 and generate a first treated stream 22 having a first reduced amount of COD. In an embodiment and as shown in FIG. 2, to arrive at the first treated stream 22, the first carbon stage 14 comprises a first vessel 24 comprising a first amount of activated carbon 26 therein in fluid communication with a first separator 28. As used herein, vessel, e.g., 24, may be closed or open, such as by having an open top. The first amount of activated carbon 26 may comprise powdered activated carbon (PAC), granular activated carbon (GAC), or a combination thereof. In addition, the first amount of activated carbon 26 is effective to remove a first amount of chemical oxygen demand (COD) from the wastewater stream 12 and generate a first material 30. The first material 30 comprises a mixture of the first treated stream 22 and a first solids portion 32 comprising at least the first amount of activated carbon 26.

In certain embodiments and as shown in FIG. 2, a first amount of biomass 34 is also optionally combined or integrated with the activated carbon 26 in the first vessel 24 to reduce an amount of biodegradable COD in the wastewater stream 12. When the first vessel 24 comprises the first amount of biomass 34 therein, the first vessel 24 may be referred to as a bioreactor as known in the art and the solids portion 32 will thus include (used or spent) activated carbon and biomass. In such case, the first amount of biomass 34 degrades readily biodegradable COD while the first amount of activated carbon 26 is effective to remove an amount of recalcitrant organics in the wastewater stream 12 delivered to the first carbon stage 14. As used herein, recalcitrant organics define a class of organics which may be slow or difficult to biodegrade relative to the bulk of organics in the wastewater stream 12, for example, as defined by Standard Methods or EPA methods, for determining BODS and the like.

The first amount of biomass 34 may include any suitable population of bacterial micro-organisms effective to digest biodegradable material, including one that does so with reduced solids production. Exemplary wastewater treatment with reduced solids production are described in U.S. Pat. Nos. 6,660,163; 5,824,222; 5,658,458; and 5,636,755, each of which are incorporated by reference herein in their entireties. The bacteria may comprise any bacteria or combination of bacteria suitable to thrive in anoxic and/or aerobic conditions. Representative aerobic genera include the bacteria Acinetobacter, Pseudomonas, Zoogloea, Achromobacter, Flavobacterium, Norcardia, Bdellovibrio, Mycobacterium, Shpaerotilus, Baggiatoa, Thiothrix, Lecicothrix, and Geotrichum, the nitrifying bacteria Nitrosomonas, and Nitrobacter, and the protozoa Ciliata, Vorticella, Opercularia, and Epistylis. Representative anoxic genera include the denitrifying bacteria Achromobacter, Aerobacter, Alcaligenes, Bacillus, Brevibacterium, Flavobacterium, Lactobacillus, Micrococcus, Proteus, Pserudomonas, and Spirillum.

Referring again to FIG. 2, the first separator 28 is in fluid communication with the first vessel 24 and is configured to receive the first material 30 within one or more inputs therein and then separate the first treated stream 22 (comprising a first reduced amount of COD from the wastewater stream 12) from the first solids portion 32 comprising at least the first amount of activated carbon 26. The first separator 28 may comprise any suitable structure employing a process effective to separate the first treated stream 22 from the solids portion 32. In an embodiment, the first separator 28 comprises one or more clarifiers, membrane units, combinations thereof or the like. The first separator 28 further includes at least an outlet for exit of the separated first treated stream 22 therefrom and delivery to the oxidation stage 16.

In certain embodiments, the first separator 28 comprises a clarifier as is well known in the art. In other embodiments, the first separator 28 comprises a dissolved gas unit, a hydrocyclone, or a membrane unit which may, for example, comprise one or more porous or semipermeable membranes. In an embodiment, the membrane unit comprises a microfiltration membrane or an ultrafiltration membrane as is known in the art. In addition, the membranes of the membrane unit may have any configuration suitable for its intended application, such as a sheet or hollow fibers or monolithic. Further, the membranes may have any suitable porosity and/or permeability for their intended application. Still further, the membranes may have any suitable shape and cross sectional area such as, for example, a square, rectangular, or cylindrical shape. In one embodiment, the membranes have a rectangular shape. In addition, the one or more membranes may be positioned, e.g., vertically, in a treatment zone of the membrane unit in such a way as to be completely submerged by the wastewater stream 12. In certain embodiments, the first vessel 24 and the first separator 28 comprise discrete individual components. It is understood, however, that the present invention is not so limited.

In other embodiments and as shown in FIG. 3, the first vessel 24 (comprising activated carbon 26 and optionally biomass 34) may be integrated with the first separator 28 and comprise a single component, e.g., a membrane bioreactor 36, as is known in the art. In this case, the membrane bioreactor 36 of the first carbon stage 14 is configured to receive the wastewater stream 12, reduce an amount of COD in the wastewater stream 12 via contact with the first amount of activated carbon 26 and biomass 34 (if present), and separate the resulting first treated stream 22 from the first material 32 comprising activated carbon (and optionally biomass) via one or more membranes as described herein housed within the membrane bioreactor 36. The first treated stream 22 may likewise exit an outlet of the membrane bioreactor 36 and be directed to the oxidation stage 16 (FIG. 1).

Referring again to FIG. 1, at the oxidation stage 16, the oxidation stage 16 may comprise one or oxidation units 38, each configured for containing a volume of the first treated stream 22, if needed and oxidizing an amount of the COD in the first treated stream 22, thereby generating a second treated stream 40 therefrom comprising a second reduced amount of COD. The second reduced amount of COD is a reduced amount of COD relative to the first treated stream 22, and thus is a second reduced amount relative to the wastewater stream 12. In addition, the oxidation unit 38 comprises any suitable vessel and structure for delivering employing ozone, ultraviolet light, hydrogen peroxide, either separately or in any combination, such as by using ultraviolet light to enhance the action of hydrogen peroxide, or any other suitable technique for oxidizing contaminants contributing to the COD in the wastewater stream 12. Thus, in an embodiment, an oxidation process takes place at the oxidation stage 16 by subjecting a stream introduced thereto (e.g., first treated stream 22) to an oxidation process, such as by subjecting the first treated stream 22 to an effective amount of ozone, hydrogen peroxide, ultraviolet light at a suitable wavelength, or any other suitable oxidant/oxidizing agent or a combination thereof effective to reduce an amount of COD from the first treated stream 22 and generate a second treated stream 40 therefrom comprising a second reduced amount of COD.

As set forth above, the presence of the oxidation stage 16 substantially reduces a total carbon consumption needed in the system 10 to generate a final treated stream 20 having a COD concentration below a predetermined amount, e.g., below the stringent COD requirements. In an embodiment, the (final) treated stream 20 from a system or process as described herein comprises a COD concentration of 50 mg/L or less, and in a particular embodiment of 30 mg/L or less. In certain embodiments, the second reduced amount of COD of the second treated stream 40 comprises an increased fraction of biodegradable COD relative to the first treated stream 22 upon the subjecting the first treated stream 22 to an oxidation process. The increased biodegradable fraction renders the COD more easily reduced in the second carbon stage 18.

The second carbon stage 18, for example, as shown in the embodiment of FIG. 4, may comprise any suitable configuration as described herein for the first carbon stage 14. In the interest of brevity, each embodiment of the second carbon stage 18 will not be described below; however, it is understood that any description of the first carbon stage 14 may be likewise utilized for the second carbon stage 18. The difference between the first carbon stage 14 and the second carbon stage 18 lies in the fact that the first carbon stage 14 is disposed upstream of the oxidation stage 16 (oxidizing step) and the second carbon stage 18 is downstream thereof in the flow direction of the wastewater 12 being treated.

The second carbon stage 18 may likewise comprise any suitable structures in a configuration which utilizes at least a second amount of activated carbon to contact a stream therein (second treated stream 40) to reduce a third amount of chemical oxygen demand (COD) (relative the wastewater stream 12) and generate a final treated stream 20 having a third reduced amount of COD. In certain embodiments, the third reduced amount of COD is at or below a maximum allowable limit of the COD, e.g., <50 mg/L. Similar to the first carbon stage 14, in certain embodiments (shown in FIG. 4), the second carbon stage 18 may similarly comprise a second vessel 42 comprising a second amount of activated carbon 44 therein and a second separator 46. The second amount of activated carbon 44 may comprise powdered activated carbon (PAC), granular activated carbon (GAC), or a combination thereof.

In addition, the second amount of activated carbon 44 is effective to remove a further amount of chemical oxygen demand (COD) from the wastewater stream 12 (now in the form of the second treated stream 40) and generate a second material 48. As with the first material 30, the second material 48 comprises a mixture of the third (final) treated stream 20 and a second solids portion 50 comprising at least the second amount of activated carbon 44. Likewise, the second carbon stage 18 may comprise a second separator 46 for separating the treated stream 20 from the second solids portion 50. As with the first carbon stage 14, the second vessel 42 may further include a second amount of biomass 52 therein for treating readily biodegradable contaminants within the wastewater stream 12. Still further, in an embodiment, the second carbon stage 18 may comprise a membrane bioreactor comprising activated carbon 44 and optionally biomass 52 therein with a plurality of membranes housed therein as was described above.

In view of the above, in accordance with an aspect and as shown in FIG. 5, the system 10 may comprise (in flow series) a first bioreactor 25 comprising a first amount of activated carbon and a first amount of biomass therein for generating the first material 30, a first separator 28 for separating the first material 30 into the first treated stream 22 and the first solids portion 32, an oxidation stage 16 for oxidizing components of the first treated stream to generate the second treated stream 40, and a second bioreactor 35 comprising a second amount of activated carbon and a second amount of biomass therein for generating the second material 48, a second separator 46 for separating the second 48 into the third (final) treated stream 20 and the second solids portion 50.

In accordance with another aspect, the activated carbon (and biomass if present) may be cycled through the system to limit the need for the addition of fresh carbon, which would add to the overall carbon consumption. Referring to FIG. 6, the system 10 may further comprise a conduit 62 in fluid communication between the second separator 46 and the first vessel 24 for delivery of at least a portion of the second solids portion 50 comprising activated carbon (and optionally biomass) from the second separator 46 to the first vessel 24. In addition, in certain embodiments, the system 10 may instead or further comprise a conduit 64 in fluid communication between the first separator 28 and the first vessel 24 for delivery of the at least a portion of the first solids portion 32 comprising activated carbon (and optionally biomass) from the first separator 28 to the first vessel 24. Further, in certain embodiments, the system 10 may instead or further comprise a conduit 66 in fluid communication between the second separator 46 and the second vessel 42 for delivery of at least a portion of the second solids portion 50 comprising activated carbon (and optionally biomass) from the second separator 46 to the second vessel 42. With any of conduits 62, 64, and/or 66, activated carbon (and optionally biomass) may thus be reused within the system 10.

It is appreciated that at a certain point, the activated carbon in the first or second stage 14, 18 becomes “spent”—meaning that its ability to adsorb or otherwise remove chemical oxygen demand from the wastewater stream 12 becomes compromised. In accordance with another aspect of the present invention, the total carbon consumption of the system 10 may further be minimized via addition of a WAO 54, which may regenerate spent carbon from the first carbon stage 14 and/or second carbon stage 18, and recycle regenerated carbon to the first and/or second carbon stage 14, 18. Referring now to FIG. 7, there is the system 10 as previously described herein comprising, in a direction of flow of the wastewater stream, a first carbon stage 14, oxidation stage 16, and a second carbon stage 18. A treated stream 20 having a COD concentration below a predetermined threshold exits the second carbon stage 18. In certain embodiments, the treated stream 20 comprises a COD concentration of 50 mg/L or less, and in certain embodiments from 30 mg/L or less.

In accordance with an aspect of the present invention, when the activated carbon in the first carbon stage 14 and/or second carbon stage 18 comprises an amount of spent carbon, the system 10 may further include a WAO unit 54 (also shown in FIG. 7) for regenerating the spent carbon, thereby further reducing the need for added carbon in the system 10. As shown by the arrows 56, 58, following separation in the stages 14, 18, the first solids portion 32 is directed to the WAO unit 54. When biomass is also present in the first and/or second carbon stage 14, 18, the WAO unit 54 may also serve to destroy biological solids from the first solids portion 32 and/or second solids portion 50 delivered to the WAO unit 54. The WAO unit 54 comprises one or more dedicated reactor vessels in which WAO of the spent carbon material (and destruction of biomass when present) takes place at elevated temperature and pressure (relative to atmospheric conditions), and in the presence of oxygen.

In an embodiment, the WAO process is carried out at a temperature of 150° C. to 320° C. (275° F. to 608° F.) at a pressure of 10 to 220 bar (150 to 3200 psi). Further, in an embodiment, the material introduced to the WAO unit 54 may be mixed with an oxidant, e.g., a pressurized oxygen-containing gas supplied by a compressor. The oxidant may be added to the material (e.g., prior to and/or after flow of the material (solids portion 32 and/or 50) through a heat exchanger (not shown). Within the WAO unit 54, the material therein is subjected to conditions effective to oxidize contaminants adsorbed on the activated carbon, thereby regenerating the activated carbon material and destroying the biological material (when present). A gaseous portion (offgas) may also be produced having an oxygen content. As shown by double sided arrows 56, 58, the regenerated carbon material 60 may be recycled back to the first carbon stage 14 and/or second carbon stage 18, and well as receive material therefrom. To facilitate movement of the regenerated carbon material 60 through the system 10, the system may further include suitable fluid connections between the components of the system 10.

By way of example, FIG. 8 illustrates another embodiment of system 10 further comprising a WAO unit 54, particularly showing the flow of the components, including spent and regenerated carbon through the system. In this embodiment, the system 10 may comprise: a conduit 80 between the first vessel 24 and the first separator 28 for delivery of the first material 30 to the first separator 28; a conduit 64 between the first separator 28 and the first vessel 24 for recirculation of activated carbon (and optionally biomass) therebetween; a conduit 68 between the first separator 28 and the oxidation stage 16 for delivery of the first treated stream 22 to the oxidation stage; a conduit 70 between the oxidation stage 16 and the second vessel 42 for delivery of the second treated stream 40 the second vessel 42; a conduit 72 for the introduction of fresh activated carbon into the second vessel 42; a conduit 66 between the second vessel 42 and the second separator 46 for delivery of the second material 48 to the second separator 46; a conduit 74 between the second separator 46 and the WAO unit 54 for delivery of the second solids portion 50 to the second separator 46; a conduit 76 between the WAO unit 54 and the first vessel 24 for recirculation/delivery of regenerated material 60 thereto; a conduit 78 between the WAO unit 54 and the second vessel 42 for recirculation of the regenerated material 60 to the second vessel; and/or a conduit 62 in fluid communication between the second separator 46 and the first vessel 24 for delivery of at least a portion of the second solids portion 50 comprising activated carbon (and optionally biomass) from the second separator 46 to the first vessel 24. It is appreciated that the term “recirculation line” may be utilized with any of the conduits described herein as the conduits allow for repeated movement and reuse of materials through the system.

In accordance with an aspect of the present invention, any of the embodiments of the system 10 as described herein may further comprise suitable components within flow paths of any one of the conduits 60-80 for removing and storing (at least temporarily) any of the materials flowing therethrough. In an embodiment, for example and as shown in FIG. 9, the system 10 may further comprise a purge and storage system 82 to remove and store a portion of the first and/or second solids portions 32, 50 comprising activated carbon and optionally biomass from the first separator 28 and/or second separator 46. In addition, when present, the WAO unit 54 may be in fluid communication with the activated carbon and biomass purge and storage system 82 for regenerating an amount of spent activated carbon and destroying biomass delivered from the purge and storage system 82 to the WAO system 54. The purge and storage system 82 may comprise any suitable number of vessels and pumps delivering positive and/or negative pressure for storage and delivery of the desired materials. For example, spent activated carbon and/or biomass may be recycled 51 to the first vessel 24. From the WAO 54, regenerated carbon 60 may then be returned to the first vessel 24 and/or second vessel 42. In certain aspects, in any embodiment of a system 10 as described herein, the system 10 may further include a polishing unit (now shown) downstream of the second carbon stage for removing further COD and/or suspended solids therefrom. The polishing unit may comprise any suitable component, such as a membrane unit, reverse osmosis unit, ion exchange or the like.

To reiterate, the systems and processes for reducing the overall carbon consumption needed for the generation of low COD treated water. In certain aspects, the systems and processes described herein include an oxidation stage between a first activated carbon stage and a second activated carbon stage to reduce a total carbon consumption within the associated system or process. In certain aspects, the total carbon consumption is reduced due to an increased biodegradable COD portion as a result of an oxidation process (e.g., ozone treatment). As a result, a lesser amount of carbon is needed in the second stage (e.g., more biomass can be utilized). In this way, the total carbon consumption for the system may also be reduced.

While various embodiments of the present invention have been shown and described herein, it will be obvious that such embodiments are provided by way of example only. Numerous variations, changes, and substitutions may be made without departing from the invention herein. Accordingly, it is intended that the invention be limited only by the spirit and scope of the appended claims.

1. A water treatment system comprising:
a first carbon stage comprising a first vessel containing at least a first amount of activated carbon effective to reduce a first amount of chemical oxygen demand (COD) from a wastewater stream and generate a first treated stream having a first reduced amount of COD;
an oxidation unit disposed downstream of the first carbon stage, the oxidation unit configured to oxidize a second amount of COD from the first treated stream and generate a second treated stream having a second reduced amount of COD;
a second carbon stage downstream of the oxidation unit comprising a second vessel containing at least a second amount of activated carbon effective to reduce a third amount of chemical oxygen demand (COD) from the second treated stream and generate a third treated stream having a third reduced amount of COD at or below a predetermined concentration limit.

2. The system of claim 1, wherein the first carbon stage, the second carbon stage, or both stages further comprise an amount of biological material therein for reducing the first amount and/or the third amount of COD.

3. The system of claim 1, wherein the oxidation unit comprises an oxidation unit configured for subjecting the first treated stream to at least one of an amount of ozone, hydrogen peroxide, and ultraviolet light effective to reduce the second amount of COD from the first treated stream.

4. The system of claim 1, wherein the first vessel is configured to remove the first amount of COD from the wastewater stream and generate a first material comprising the first treated stream and a first solids portion comprising the first amount of activated carbon; and
a first separator in fluid communication with the first vessel, the first separator configured to separate the first treated stream from the first solids portion.

5. The system of claim 1, wherein the second vessel is configured to remove the second amount of COD from the wastewater stream and generate a second material comprising the third treated stream and a second solids portion comprising the second amount of activated carbon; and
a second separator in fluid communication with the second vessel, the second separator configured to separate the third treated stream from the second solids portion.

6. The system of claim 1, wherein the first vessel comprises a first bioreactor, and wherein the first bioreactor comprises the first amount of activated carbon and a first amount of biomass therein, the first bioreactor configured to remove the first amount of COD from the wastewater stream and generate a first material comprising the first treated stream and a first solids portion comprising the first amount of activated carbon and biomass; and
a first separator in fluid communication with the first bioreactor, the first separator configured to separate the first treated stream from the solids portion.

7. The system of claim 1, wherein the first vessel comprises a first membrane bioreactor comprising the first amount of activated carbon, a first amount of biomass, and a plurality of membranes therein, the first membrane bioreactor configured to remove the first amount of COD from the wastewater stream, generate a first material comprising the first treated stream and a first solids portion comprising the first amount of activated carbon and biomass, and separate the first treated stream from the first solids portion.

8. The system of claim 1, wherein the second vessel comprises a second bioreactor, and wherein the second bioreactor comprises the second amount of activated carbon and a second amount of biomass therein, the second bioreactor configured to remove the third amount of COD from the wastewater stream and generate a second material comprising the third treated stream and a second solids portion comprising the second amount of activated carbon and biomass; and
a second separator in fluid communication with the second bioreactor, the second separator configured to separate third treated stream and the second solids portion.

9. The system of claim 1, wherein the second vessel comprises a second membrane bioreactor comprising the second amount of activated carbon, a second amount of biomass, and a plurality of membranes therein, the second membrane bioreactor configured to remove the third amount of COD from the second treated stream, generate the second treated stream and the second material comprising the second amount of activated carbon and biomass, and separate the third treated stream from the second material.

10. The system of claim 1, further comprising:
a wet air oxidation unit configured to regenerate an amount of spent carbon input from the first carbon stage and/or second carbon stage; and
a recirculation line for recycling an amount of regenerated carbon from the wet air oxidation unit to the first carbon stage and/or second carbon stage.

11. The system of claim 1, wherein the second reduced amount of COD of the second treated stream further comprises at least one of an increased fraction of biodegradable COD and an overall decrease in COD relative to the first treated stream upon oxidation of the first treated stream in the oxidation unit.

12. A water treatment process comprising:
generating a first treated stream having a first reduced amount of COD via contacting a wastewater stream with a first amount of activated carbon;
generating a second treated stream having a second reduced amount of COD via subjecting the first treated stream to an oxidation process; and
generating a third treated stream having a third reduced amount of COD at or below a predetermined concentration limit via contacting the second treated stream with at least a second amount of activated carbon;
wherein, relative to a process without the oxidation step, the oxidation process reduces a total carbon consumption required to bring the COD to or below the predetermined concentration limit.

13. The process of claim 12, wherein the oxidation process comprises contacting the first treated stream with an amount of at least one of ozone hydrogen peroxide, and ultraviolet light effective to generate the second treated stream.

14. The process of claim 12, wherein the generating a first treated stream comprises:
treating the wastewater stream in a first vessel comprising a first amount of activated carbon effective to generate a first material comprising the first treated stream and a first solids portion comprising the first amount of activated carbon;
separating the first material into the first treated stream and the first solids portion.

15. The process of claim 13, wherein the generating a first treated stream further comprises:
contacting the wastewater stream with a first amount of biomass to generate the first treated stream, and wherein the first solids portion further comprises the first amount of biomass.

16. The process of claim 12, wherein the first solids portion comprises a first amount of spent carbon, and further comprising subjecting the first solids portion to a wet air oxidation process to regenerate the first amount of spent carbon and provide a first amount of regenerated carbon.

17. The process of claim 12, wherein the generating a second treated stream comprises:
treating the wastewater stream in a second vessel comprising a second amount of activated carbon effective to generate a second material comprising the third treated stream and a second solids portion comprising the second amount of activated carbon;
separating the second material into the third treated stream and the second solids portion.

18. The process of claim 17, wherein the generating a second treated stream further comprises:
contacting the wastewater stream with a second amount of biomass to generate the second treated stream, and wherein the second solids portion further comprises the second amount of biomass.

19. The process of claim 17, wherein the second solids portion comprises an amount of spent carbon, and further comprising:
subjecting the second solids portion to a wet air oxidation process to provide a second amount of regenerated carbon material; and
utilizing the second amount of regenerated carbon to generate the first treated stream or the third treated stream.

20. The process of claim 12, wherein the predetermined concentration is 50 mg/L or less.

21. The process of claim 12, wherein the second reduced amount of COD of the second treated stream further comprises at least one of an increased fraction of biodegradable COD and an overall decrease in COD relative to the first treated stream upon the subjecting the first treated stream to an oxidation process.

22. A water treatment system comprising:
a first bioreactor comprising a first amount of activated carbon and a first amount of biomass, the first bioreactor configured to remove a first amount of chemical oxygen demand (COD) from a wastewater stream introduced thereto and to generate a first treated stream comprising a first reduced amount of COD along with a first solids portion comprising the first amount of activated carbon and biomass;
a first separator in fluid communication with the first bioreactor, the first separator configured to separate the first treated stream from the first solids portion;
an oxidation unit in fluid communication with first separator, the oxidation unit configured to oxidize an amount of the COD in the first treated stream and generate a second treated stream comprising a second reduced amount of COD;
a second bioreactor comprising a second amount of activated carbon and a second amount of biomass in fluid communication with the oxidation unit, the second bioreactor configured to remove a third amount of COD from the second treated stream to generate a third treated stream comprising a reduced amount of COD along with a second solids portion comprising the second amount of activated carbon and biomass; and
a second separator in fluid communication with the second bioreactor, the second separator configured to separate the third treated stream from the second solids portion.

23. (canceled)

24. The system of claim 22, further comprising:
an activated carbon and biomass solids purge and storage system configured to remove and/or store a portion of the first solids portion and the second solids portion from the first and/or second separators; and
a wet air regeneration unit in fluid communication with the activated carbon and biomass purge and storage system configured to regenerate an amount of spent activated carbon and destroy biomass from the first and/or second solids portions.

25. The system of claim 22, wherein the wet air regeneration unit is in fluid communication with the first separator for regenerating an amount of spent carbon in the first solids fraction, and further comprising a first recirculation line from the wet air regeneration unit to the second bioreactor for delivery of regenerated activated carbon from the wet air regeneration unit to the second bioreactor.

26. (canceled)

27. The system of claim 22, wherein the oxidation unit comprises an oxidation unit configured to oxidize an amount of the COD in the first treated stream using at least one of ozone, hydrogen peroxide, and ultraviolet lights, and generate a second treated stream comprising at least one of second reduced amount of COD and an increase of biodegradable COD;

28-38. (canceled)
